(19) United States
(12) Patent Application Publication
(10) Pub. No.: US 2018/0176941 A1
(43) Pub. Date: Jun. 21, 2018

(54) Communication method and apparatus and storage medium

(71) Applicant: ZTE Corporation, Shenzhen (CN)

(72) Inventors: Kun Liu, Shenzhen (CN); Bo Dai, Shenzhen (CN); Zhaohua Lu, Shenzhen (CN); Shuqiang Xia, Shenzhen (CN); Xianming Chen, Shenzhen (CN); Jing Shi, Shenzhen (CN); Wen Zhang, Shenzhen (CN); Huiying Fang, Shenzhen (CN)

(21) Appl. No.: 15/563,601

(22) PCT Filed: Sep. 8, 2015
(86) PCT No.: PCT/CN2015/089153

§ 371 Date: Dec. 26, 2017

(30) Foreign Application Priority Data
Apr. 9, 2015 (CN) 201510167156.3

(51) Int. Cl. H04W 72/12; H04W 72/04

(52) U.S. Cl. CPC H04W 72/1289; H04W 74/0833; H04W 72/0446

(57) ABSTRACT

Disclosed is a communication method. The method comprises: a second node acquiring first configuration information sent by a first node; and according to the first configuration information, sending a first message to the first node, wherein the first configuration information is used for determining a sending time of the first message. Also disclosed are a communication apparatus and a storage medium.

### TECHNICAL FIELD

The disclosure relates to the field of communication technology, and in particular to a communication method and device, and a storage medium.

### BACKGROUND

At present, a Machine to Machine (M2M) terminal in the market is mainly based on a Global System of Mobile communication (GSM) system. In recent years, due to the improvement of spectral efficiency of Long Term Evolution (LTE)/Long Term Evolution-Advanced (LTE-A), more and more mobile operators select the LTE/LTE-A as the future evolution direction of broadband wireless communication system; however, only when the cost of an LTE-M2M device is lower than that of a Machine-Type Communication (MTC) terminal of the GSM system, can M2M services be transferred from the GSM system to an LTE system.

The cost reduction of the LTE-M2M device means performance degradation. For an LTE-M2M device with low cost and an LTE-M2M device in basement, corner or other bad communication conditions, it is necessary to perform uplink and downlink Coverage Enhancement (CE), and the problem arising is how to ensure the access quality of the LTE-M2M device, so that the LTE-M2M device can access the system normally.

### SUMMARY

In view of the above, the disclosure is intended to provide a communication method and device, and a storage medium, which can improve a random access performance of a terminal, reduce an access delay, and enhance user experience.

To this end, the technical solutions of the disclosure are implemented as follows.

The disclosure provides a communication method, which includes:

a second node acquires first configuration information sent by a first node; and

the second node sends a first message to the first node according to the first configuration information;

herein, the first configuration information is used for determining a time of sending the first message.

In the above solution, before the second node sends the first message to the first node according to the first configuration information, the method further includes: a second message sent by the first node is received.

In the above solution, the step that the second acquires the first configuration information sent by the first node comprises includes:

the second node acquires the first configuration information through the second message sent by the first node; or

the second node acquires the first configuration information through System Information (SI) sent by the first node; or

the second node acquires the first configuration information through scheduling information of the second message sent by the first node.

In the above solution, the first configuration information comprises: a first time interval M;

correspondingly, the step that the time of sending the first message is determined comprises:

a time after a first time is determined as a second time, herein the time interval length between the first time and the second time is M, and a time corresponding to a first available uplink Resource Block (RB) after the second time is determined as the time of sending the first message; or, a time corresponding to a first uplink RB after the second time is determined as the time of sending the first message.

In the above solution, when a mode of sending the second message is a non-repeated sending mode, the first time is the time of sending the second message; or

when the mode of sending the second message is a non-repeated sending mode, the first time is the time when sending of the second message is started; or

when the mode of sending the second message is a non-repeated sending mode, the first time is the time when sending of the second message is ended; or

when the mode of sending the second message is a repeated sending mode, the first time is a time when sending of a second message corresponding to the level of the second node is ended for the last time; or

when the mode of sending the second message is a repeated sending mode, the first time is the time when sending of the second message is ended for the last time; or

the first time is a start time of a detection time window of the second message corresponding to the level of the second node; or

the first time is an end time of the detection time window of the second message corresponding to the level of the second node; or

the first time is a start time of the detection time window of the second message; or

the first time is an end time of the detection time window of the second message.

In the above solution, the scheduling information of the second message is included in Downlink Control Information (DCI).

In the above solution, the mode of sending the scheduling information of the second message by the first node is sending once or sending repeatedly;

when the mode of sending the scheduling information of the second message by the first node is sending repeatedly, the number of repeats is the number of times of sending scheduling information of a second message corresponding to the second node with the highest level among the second messages, or

the number of times of sending scheduling information of a second message corresponding to a second node with the highest level which is configured for the first node.

In the above solution, before the second message sent by the first node is received, the method further includes that: the time when sending of the second message is started is determined;

the step that the time when sending of the second message is started is determined includes:

a time after a third time is determined as a fourth time, herein the time interval length between the third time and the fourth time is N, and a time corresponding to a first available downlink RB after the fourth time is determined as the time when sending of the second message is started; or, a time corresponding to a first downlink RB after the fourth time is determined as the time when sending of the second message is started.

In the above solution, when the mode of sending the scheduling information of the second message is a non-repeated sending mode, the third time is the time of sending the scheduling information of the second message; or

when the mode of sending the scheduling information of the second message is a non-repeated sending mode, the third time is a time when sending of the scheduling information of the second message is started; or

when the mode of sending the scheduling information of the second message is a non-repeated sending mode, the third time is a time when sending of the scheduling information of the second message is ended; or

when the mode of sending the scheduling information of the second message is a repeated sending mode, the third time is a time when sending of the scheduling information of the second message is ended for the last time; or

the third time is a start time of the detection time window of the scheduling information of the second message; or

the third time is an end time of the detection time window of the scheduling information of the second message.

In the above solution, before the time when sending of the second message is started is determined, the method further comprises that: a second time interval N is acquired:

the step that the second time interval N is acquired comprises: the second time interval N is acquired through the SI; or

the second time interval N is acquired through the scheduling information of the second message.

In the above solution, the scheduling information of the second message comprises at least one of first adjustment information and first indication information.

In the above solution, the scheduling information of the second message comprises the first adjustment information;

correspondingly, the first adjustment information comprises one or more of adjustment information of a modulation order of the second message, adjustment information of a coding rate of the second message, adjustment information of a modulation coding rate of the second message, updated modulation order information of the second message, updated coding rate information of the second message, and updated modulation coding rate information of the second message.

In the above solution, the scheduling information of the second message comprises the first indication information;

correspondingly, the first indication information comprises an index of frequency band resources where the second message is, for indicating the frequency band resources where the second message is.

In the above solution, the first message comprises: a Radio Resource Control (RRC) connection request message, or an RRC connection reestablishment request message, or an RRC connection reconfiguration completion message.

In the above solution, the first message is an Msg3 message, and the second message is a Random Access Response (RAR) message.

The disclosure also provides a communication device, which is in the second node; the device includes: an acquiring module, a sending module and a determining module; herein,

the acquiring module is configured to acquire the first configuration information sent by the first node; and the sending module is configured to send the first message to the first node according to the first configuration information;

herein, the first configuration information is used for determining a time of sending the first message.

In the above solution, the device further includes a receiving module configured to receive the second message sent by the first node.

In the above solution, the acquiring module is configured to acquire the first configuration information through the second message sent by the first node; or

acquire the first configuration information through the SI sent by the first node; or

acquire the first configuration information through the scheduling information of the second message sent by the first node.

In the above solution, the first configuration information comprises: the first time interval M;

correspondingly, the determining module is configured to determine a time after a first time as a second time, herein the time interval length between the first time and the second time is M, and determine a time corresponding to the first available uplink RB after the second time as the time of sending the first message; or, the determining module is configured to determine a time corresponding to the first uplink RB after the second time is the time of sending the first message.

In the above solution, when the mode of sending the second message is a non-repeated sending mode, the first time is the time of sending the second message; or

when the mode of sending the second message is a non-repeated sending mode, the first time is a time when sending of the second message is started; or

when the mode of sending the second message is a non-repeated sending mode, the first time is a time when sending of the second message is ended; or

when the mode of sending the second message is a repeated sending mode, the first time is a time when sending of a second message corresponding to the level of the second node is ended for the last time; or

when the mode of sending the second message is a repeated sending mode, the first time is a time when sending of the second message is ended for the last time; or

the first time is a start time of the detection time window of the second message corresponding to the level of the second node; or

the first time is an end time of the detection time window of the second message corresponding to the level of the second node; or

the first time is a start time of the detection time window of the second message; or,

the first time is an end time of the detection time window of the second message.

In the above solution, the mode of sending the scheduling information of the second message by the first node is sending once or sending repeatedly;

when the mode of sending the scheduling information of the second message by the first node is sending repeatedly, the number of repeats is the number of times of sending scheduling information of a second message corresponding to the second node with the highest level among the second messages,

or the number of times of sending scheduling information of a second message corresponding to a second node with the highest level which is configured for the first node.

In the above solution, the determining module is further configured to determine the time when sending of the second message is started;

the determining module is configured to determine a time after a third time as a fourth time, herein the time interval length between the third time and the fourth time is N, and determine a time corresponding to the first available downlink RB after the fourth time as the time when sending of the second message is started; or, the determining module is configured to determine a time corresponding to the first downlink RB after the fourth time as the time when sending of the second message is started.

In the above solution, when the mode of sending the scheduling information of the second message is a non-repeated sending mode, the third time is the time of sending the scheduling information of the second message; or

when the mode of sending the scheduling information of the second message is a non-repeated sending mode, the third time is the time when sending of the scheduling information of the second message is started; or

when the mode of sending the scheduling information of the second message is a non-repeated sending mode, the third time is the time when sending of the scheduling information of the second message is ended; or

when the mode of sending the scheduling information of the second message is a repeated sending mode, the third time is the time when sending of the scheduling information of the second message is ended for the last time; or

the third time is a start time of the detection time window of the scheduling information of the second message; or

the third time is an end time of the detection time window of the scheduling information of the second message.

In the above solution, the acquiring module is further configured to acquire the second time interval N:

the acquiring module is configured to acquire the second time interval N through the SI,

or acquire the second time interval N through the scheduling information of the second message.

The disclosure also provides a computer storage medium, in which a computer program is stored; the computer program is used for performing the communication method above.

According to the communication and device, and the storage medium provided by the disclosure, the second node acquires the first configuration information sent by the first node; and the second node sends the first message to the first node according to the first configuration information; herein, the first configuration information is used for determining the time of sending the first message. As such, a random access performance of a terminal is improved, an access delay is reduced, and user experience is enhanced.

### BRIEF DESCRIPTION OF DRAWINGS

FIG. 1 is a flowchart of a communication method according to a first embodiment of the disclosure.

FIG. 2 is a flowchart of a communication method according to a second embodiment of the disclosure.

FIG. 3 is a communication timing diagram 1 in a random access scenario according to an embodiment of the disclosure.

FIG. 4 is a flowchart of a communication method according to a third embodiment of the disclosure.

FIG. 5 is a communication timing diagram 2 in a random access scenario according to an embodiment of the disclosure.

FIG. 6 is a flowchart of a communication method according to a fourth embodiment of the disclosure.

FIG. 7 is a communication timing diagram 3 in a random access scenario according to an embodiment of the disclosure.

FIG. 8 is a flowchart of a communication method according to a fifth embodiment of the disclosure.

FIG. 9 is a communication timing diagram 4 in a random access scenario according to an embodiment of the disclosure.

FIG. 10 is a structure diagram of a communication device according to an embodiment of the disclosure.

### DETAILED DESCRIPTION

In the embodiments of the disclosure, a second node acquires first configuration information sent by a first node; and the second node sends a first message to the first node according to the first configuration information; herein, the first configuration information is used for determining a time of sending the first message.

### First Embodiment

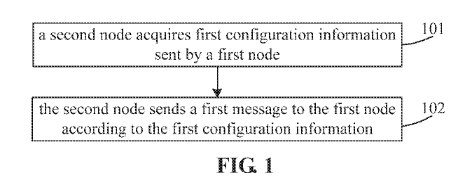

FIG. 1 is a flowchart of a communication method according to a first embodiment of the disclosure; as shown in FIG. 1, the communication method of the present embodiment includes the following steps.

In step 101, the second node acquires the first configuration information sent by the first node;

here, the first configuration information is used for the second node to determine a time of sending the first message.

This step includes that: the second node acquires the first configuration information through a second message sent by the first node; or

the second node acquires the first configuration information through SI sent by the first node; or

the second node acquires the first configuration information through scheduling information of the second message sent by the first node;

herein, the scheduling information of the second message can be included in DCI and sent through an Enhanced Physical Downlink Control Channel (EPDCCH);

the mode of sending the scheduling information of the second message by the first node is sending once, namely a non-repeated sending mode, or a repeated sending mode;

when the mode of sending the scheduling information of the second message by the first node is a repeated sending mode, the number of repeats is the number of times of sending scheduling information of a second message corresponding to the second node with the highest level among the second messages,

or the number of times of sending scheduling information of a second message corresponding to a second node with the highest level which is configured for the first node;

here, the level can be a Coverage Enhancement Level (CEL), or a Physical Random Access Channel (PRACH) CEL, or a PRACH repeated sending level;

the numbers of times of sending the scheduling information of the second messages corresponding to the second nodes with different levels are different.

In an embodiment, the first configuration information comprises: a first time interval M;

correspondingly, the step that the second node determines the time of sending the first message comprises:

the second node determines a time after a first time as a second time, herein the time interval length between the first time and the second time is M, and determines a time corresponding to a first available uplink RB after the second time as the time of sending the first message; or, the second node determines a time corresponding to a first uplink RB after the second time as the time of sending the first message.

Here, the unit of measuring the first time interval M can be subframe or frame or other units of measuring time;

for the second nodes with different levels, the lengths of the first time intervals M can be either the same or different.

In an embodiment, the method further includes that: the second node receives the second message sent by the first node; herein, the mode of sending the second message by the first node can be either a non-repeated sending, namely sending once, or a repeated sending mode; when the mode of sending the second message is a repeated sending mode, the numbers of times of sending the second messages corresponding to the second nodes with different levels are different;

correspondingly,

when the mode of sending the second message is a non-repeated sending mode, the first time is the time of sending the second message; or

when the mode of sending the second message is a non-repeated sending mode, the first time is the time when sending of the second message is started; or

when the mode of sending the second message is a non-repeated sending mode, the first time is the time when sending of the second message is ended; or

when the mode of sending the second message is a repeated sending mode, the first time is a time when sending of a second message corresponding to the level of the second node is ended for the last time; or

when the mode of sending the second message is a repeated sending mode, the first time is the time when sending of the second message is ended for the last time; or

the first time is a start time of a detection time window of the second message corresponding to the level of the second node; or

the first time is an end time of the detection time window of the second message corresponding to the level of the second node; or

the first time is a start time of the detection time window of the second message; or

the first time is an end time of the detection time window of the second message;

here, the lengths of the detection time windows of the second messages corresponding to the second nodes with different levels are different.

In an embodiment, before the second message sent by the first node is received, the method further includes that: the time when sending of the second message is started is determined;

the step that the time when sending of the second message is started is determined includes:

a time after a third time is determined as a fourth time, herein the time interval length between the third time and the fourth time is N, and a time corresponding to a first available downlink RB after the fourth time is determined as the time when sending of the second message is started; or, a time corresponding to a first downlink RB after the fourth time is determined as the time when sending of the second message is started.

herein, the lengths of the second time intervals N corresponding to the second nodes with different levels can be either the same or different; when the lengths of the second time intervals N corresponding to the second nodes with different levels are different, the value of the second time interval N corresponding to the second node with the high level is greater than the value of the second time interval N corresponding to the second node with the low level; the unit of measuring the second time interval N can be subframe or frame or other units of measuring time;

herein, when the mode of sending the scheduling information of the second message is a non-repeated sending mode, the third time is the time of sending the scheduling information of the second message; or

when the mode of sending the scheduling information of the second message is a non-repeated sending mode, the third time is the time when sending of the scheduling information of the second message is started; or

when the mode of sending the scheduling information of the second message is a non-repeated sending mode, the third time is the time when sending of the scheduling information of the second message is ended; or

when the mode of sending the scheduling information of the second message is a repeated sending mode, the third time is the time when sending of the scheduling information of the second message is ended for the last time; or

the third time is a start time of the detection time window of the scheduling information of the second message; or

the third time is an end time of the detection time window of the scheduling information of the second message;

here, the lengths of the detection time windows of the scheduling information of the second messages corresponding to the second nodes with different levels are different.

In an embodiment, before the time when sending of the second message is started is determined, the method further comprises that: a second time interval N is acquired:

the step that the second time interval N is acquired includes: the second time interval N is acquired through the SI; or

the second time interval N is acquired through the scheduling information of the second message.

In an embodiment, the scheduling information of the second message comprises at least one of first adjustment information and first indication information;

herein, the first adjustment information comprises one or more of adjustment information of a modulation order of the second message, adjustment information of a coding rate of the second message, adjustment information of a modulation coding rate of the second message, updated modulation order information of the second message, updated coding rate information of the second message, and updated modulation coding rate information of the second message;

the first adjustment information can be expressed by a relative amount and/or an absolute amount:

when the first adjustment information is expressed by the relative amount, the adjustment information includes: one or more of the adjustment information of the modulation order of the second message, the adjustment information of the coding rate of the second message and the adjustment information of the modulation coding rate of the second message;

herein, the adjustment information of the modulation order of the second message is relative to modulation order information of the second message;

the adjustment information of the coding rate of the second message is relative to coding rate information of the second message:

the adjustment information of the modulation coding rate of the second message is relative to modulation coding rate information of the second message.

When the first adjustment information is expressed by the absolute amount, the adjustment information comprises one or more of the updated modulation order information of the second message, the updated coding rate information of the second message, and the updated modulation coding rate information of the second message.

The first indication information comprises an index of frequency band resources where the second message is, for indicating the frequency band resources where the second message is.

The method of the embodiment of the disclosure can be applied to a random access process in the LTE system; in an embodiment, the first node can be a macrocell, or a microcell, or a picocell, or a femtocell, or a Low Power Node (LPN), or a relay;

there can be one or more than one second node; the second node can be a Human to Human (H2H) communication terminal, or a Machine to Machine (M2M) communication terminal, or a Device to Device (D2D) communication terminal, or an MTC terminal;

the first message can be an Msg3 message in the random access process; the second message can be an RAR message; correspondingly, the scheduling information of the second message is the scheduling information of the RAR message.

In step 102, the second node sends the first message to the first node according to the first configuration information;

this step includes that: the second node determines the time of sending the first message according to the first configuration information, and sends the first message to the first node at the time of sending the first message:

herein, the first message includes the unique identifier of the first node, for differentiating the different first nodes; the first message further includes an RRC connection request message, or an RRC connection reestablishment request message, or an RRC connection reconfiguration completion message.

In an embodiment, the mode of sending the first message can be either sending once or sending repeatedly; the numbers of times of sending the first messages corresponding to the second nodes with different levels are different.

### Second Embodiment

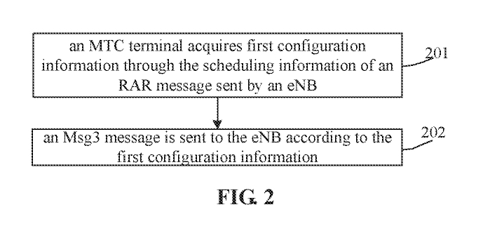

FIG. 2 is a flowchart of a communication method according to a second embodiment of the disclosure. The method of the present embodiment is applied to the random access scenario in the LTE system. In the present embodiment, the first node is an evolved NodeB (eNB); the second node is the MTC terminal UE; the MTC terminal supports CE, and the PRACH supports two Coverage Enhancement Levels (CELs), respectively CEL0 and CEL1. UE1 is the MTC UE of the CEL0, and UE2 is the MTC UE of the CEL1; the first message is the Msg3 message, and the second message is the RAR message; as shown in FIG. 2, the communication method of the present embodiment includes the following steps.

In step 201, the MTC terminal acquires the first configuration information through the scheduling information of the RAR message sent by the eNB;

here, the first configuration information is used for the MTC terminal to determine the time of sending the Msg3 message.

Before this step, the method further includes that: the eNB allocates PRACH resources for the MTC terminal, herein the PRACH resources include: a random access preamble used by random access signaling, a subframe used for sending the random access preamble and a Physical Resource Block (PRB).

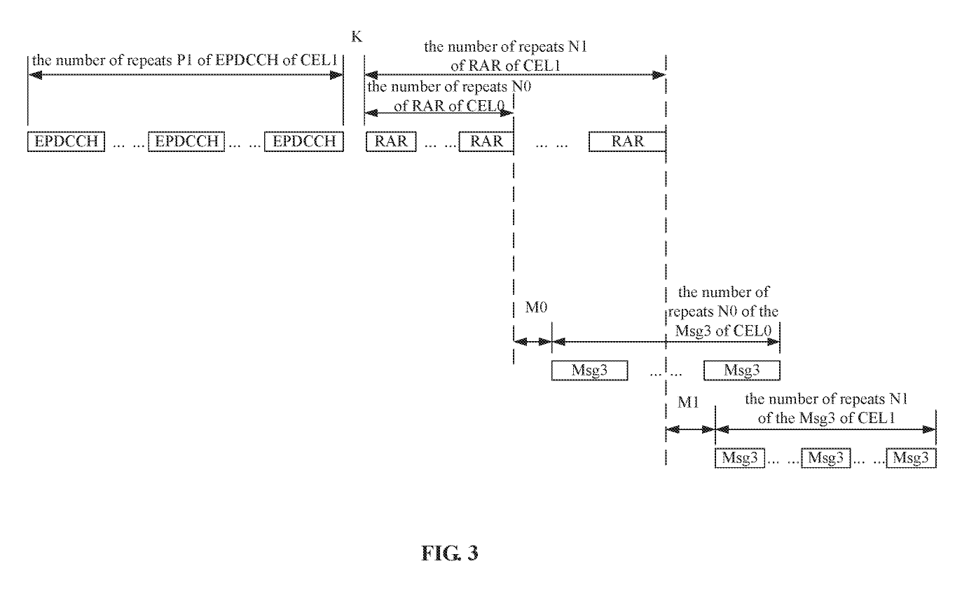

After this step, the method further includes that: the MTC terminal receives the RAR message sent by the eNB; the RAR message includes RAR information; the mode of sending the RAR message is a repeated sending mode; the numbers of times of sending the RAR messages corresponding to the MTC terminals with different levels are different; as shown in FIG. 3, the number of times of sending the RAR message corresponding to the UE1 is N0, and the number of times of sending the RAR message corresponding to the UE2 is N1.

In an embodiment, the MTC terminal can also acquire the first configuration information through the RAR message sent by the eNB or through the SI sent by the eNB.

In an embodiment, the scheduling information of the RAR message is included in the DCI and sent through the EPDCCH.

In the present embodiment, the mode of sending the scheduling information of the RAR message is a repeated sending mode, the number of repeats is the number of times of sending scheduling information of the RAR message corresponding to the MTC terminal with the highest level; as shown in FIG. 3, the number of times of sending the scheduling information of the RAR message is the number of times of sending the scheduling information of the RAR message corresponding to the UE2.

In an embodiment, the first configuration information comprises: the first time interval M;

correspondingly, the step that the MTC terminal determines the time of sending the Msg3 message comprises:

the MTC terminal determines a time after a first time as a second time, herein the time interval length between the first time and the second time is M, and determines a time corresponding to the first available uplink RB after the second time as the time of sending the Msg3 message; here, the first time is a time when sending of an RAR message corresponding to the level of the MTC terminal is ended for the last time, when the RAR message is sent repeatedly;

the unit of measuring the first time interval M can be subframe or frame or other units of measuring time; for the second nodes with different levels, the lengths of the first time intervals M can be either the same or different; in the present embodiment, the first time interval M corresponding to the UE1 is M0, and the first time interval M corresponding to the UE2 is M1, as shown in FIG. 3.

In an embodiment, before the MTC terminal receives the RAR message sent by the eNB, the method further includes that: the MTC terminal determines the time when sending of the RAR message is started:

the step that the MTC terminal determines the time when sending of the RAR message is started includes:

the MTC terminal determines a time after a third time as a fourth time, herein the time interval length between the third time and the fourth time is N, and determines a time corresponding to the first available downlink RB after the fourth time as the time when sending of the RAR message is started; or, the MTC terminal determines the time corresponding to the first downlink RB after the fourth time as the time when sending of the RAR message is started:

herein, the lengths of the second time intervals N corresponding to the MTC terminals with different levels can be either the same or different; when the lengths of the second time intervals N corresponding to the MTC terminals with different levels are different, the value of the second time interval N corresponding to the MTC terminal with the high level is greater than the value of the second time interval N corresponding to the MTC terminal with the low level; the unit of measuring the second time interval N can be subframe or frame or other units of measuring time; in the present embodiment, the lengths of the second time intervals N corresponding to the UE1 and the UE2 are the same; and the length of the second time interval N is K subframes, as shown in FIG. 3;

the third time is a time when sending of the scheduling information of the RAR message is ended for the last time, as shown in FIG. 3.

In an embodiment, before the time when sending of the RAR message is started is determined, the method further comprises that: the second time interval N is acquired:

the step that the second time interval N is acquired includes: the second time interval N is acquired through the SI; or, the second time interval N is acquired through the scheduling information of the RAR message.

In an embodiment, the scheduling information of the RAR message comprises at least one of the first adjustment information and the first indication information;

herein, the first adjustment information comprises one or more of the adjustment information of the modulation order of the RAR message, the adjustment information of the coding rate of the RAR message, the adjustment information of the modulation coding rate of the RAR message, the updated modulation order information of the RAR message, the updated coding rate information of the RAR message, and the updated modulation coding rate information of the RAR message;

the first adjustment information can be expressed by the relative amount and/or the absolute amount:

when the first adjustment information is expressed by the relative amount, the adjustment information includes: one or more of the adjustment information of the modulation order of the RAR message, the adjustment information of the coding rate of the RAR message and the adjustment information of the modulation coding rate of the RAR message;

herein, the adjustment information of the modulation order of the RAR message is relative to the modulation order information of the RAR message;

the adjustment information of the coding rate of the RAR message is relative to the coding rate information of the RAR message:

the adjustment information of the modulation coding rate of the RAR message is relative to the modulation coding rate information of the RAR message.

When the first adjustment information is expressed by the absolute amount, the adjustment information comprises one or more of the updated modulation order information of the RAR message, the updated coding rate information of the RAR message, and the updated modulation coding rate information of the RAR message.

The first indication information comprises the index of frequency band resources where the RAR message is, for indicating the frequency band resources where the RAR message is.

In step 202, the Msg3 message is sent to the eNB according to the first configuration information;

this step includes that: the MTC terminal determines the time of sending the Msg3 message according to the first configuration information, and sends the Msg3 message to the eNB at the time of sending the Msg3 message;

herein, the Msg3 message includes the unique identifier of the MTC terminal, for differentiating the different MTC terminals; the Msg3 message further includes the RRC connection request message, or the RRC connection reestablishment request message, or the RRC connection reconfiguration completion message.

In an embodiment, the mode of sending the Msg3 message is a repeated sending mode; the numbers of times of sending the Msg3 messages corresponding to the MTC terminals with different levels are different; as shown in FIG. 3, the number of times of sending the Msg3 message corresponding to the UE is N0, and the number of times of sending the Msg3 message corresponding to the UE2 is N1.

### Third Embodiment

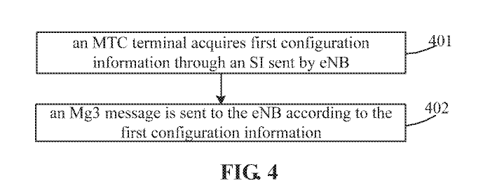

FIG. 4 is a flowchart of a communication method according to a third embodiment of the disclosure. The method of the present embodiment is applied to the random access scenario in the LTE system. In the present embodiment, the first node is the eNB; the second node is the MTC terminal UE; the MTC terminal supports the CE, and the PRACH supports two CELs, respectively CEL0 and CEL1. UE1 is the MTC UE of the CEL0, and UE2 is the MTC UE of the CEL1; the first message is the Msg3 message, and the second message is the RAR message; as shown in FIG. 4, the communication method of the present embodiment includes the following steps.

In step 401, the MTC terminal acquires the first configuration information through the SI sent by the eNB:

here, the first configuration information is used for the MTC terminal to determine the time of sending the Msg3 message.

Before this step, the method further includes that: the eNB allocates the PRACH resources for the MTC terminal, herein the PRACH resources include: the random access preamble used by the random access signaling, the subframe used for sending the random access preamble and the PRB.

After this step, the method further includes that: the MTC terminal receives the RAR message sent by the eNB; the RAR message includes the RAR information; the mode of sending the RAR message is a repeated sending mode; the numbers of times of sending the RAR messages corresponding to the MTC terminals with different levels are different.

In an embodiment, the first configuration information includes: the first time interval M:

correspondingly, the step that the MTC terminal determines the time of sending the Msg3 message comprises:

the MTC terminal determines a time after a first time as a second time, herein the time interval length between the first time and the second time is M. and determines a time corresponding to the first available uplink RB after the second time as the time of sending the Msg3 message; or, the MTC terminal determines a time corresponding to the first uplink RB after the second time is the time of sending the Msg3 message;

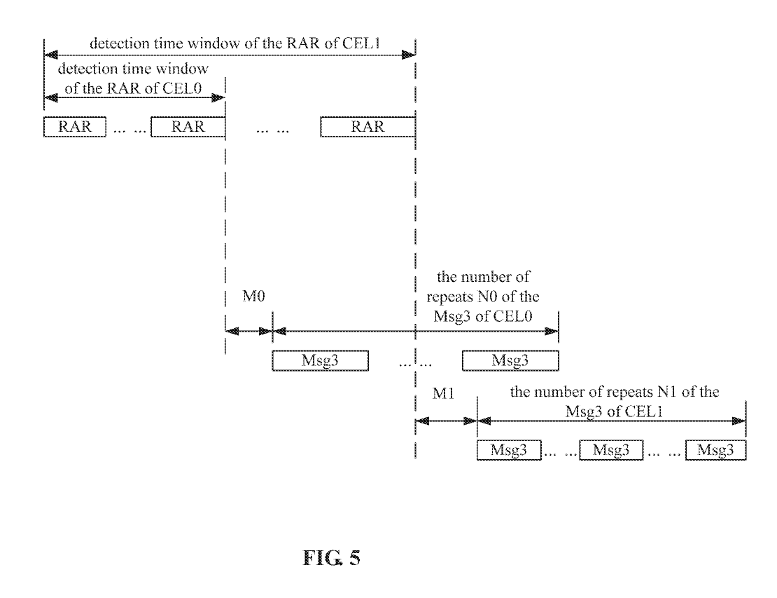

here, the first time is the end time of the detection time window of the RAR message corresponding to the level of the MTC terminal, when the RAR message is sent repeatedly, as shown in FIG. 5;

the unit of measuring the first time interval M can be subframe or frame or other units of measuring time; for the second nodes with different levels, the lengths of the first time intervals M can be either the same or different; in the present embodiment, the first time interval M corresponding to the UE1 is M0, and the first time interval M corresponding to the UE2 is M1, as shown in FIG. 5.

In step 402, the Mg3 message is sent to the eNB according to the first configuration information;

this step includes that: the MTC terminal determines the time of sending the Msg3 message according to the first configuration information, and sends the Msg3 message to the eNB at the time of sending the Msg3 message;

herein, the Msg3 message includes the unique identifier of the MTC terminal, for differentiating the different MTC terminals; the Msg3 message further includes the RRC connection request message, or the RRC connection reestablishment request message, or the RRC connection reconfiguration completion message.

In an embodiment, the mode of sending the Msg3 message is a repeated sending mode; the numbers of times of sending the Msg3 messages corresponding to the MTC terminals with different levels are different; as shown in FIG. 5, the number of times of sending the Msg3 message corresponding to the UE1 is N0, and the number of times of sending the Msg3 message corresponding to the UE2 is N1.

### Fourth Embodiment

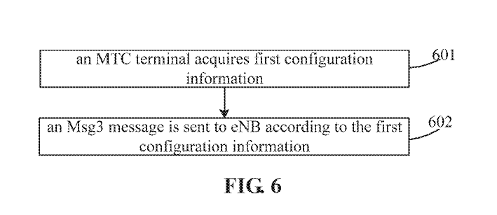

FIG. 6 is a flowchart of a communication method according to a fourth embodiment of the disclosure. The method of the present embodiment is applied to the random access scenario in the LTE system. In the present embodiment, the first node is the eNB; the second node is the MTC terminal UE; the MTC terminal supports the CE, and the PRACH supports three CELs, respectively CEL0, CEL1 and CEL2; the higher the CE is, the stronger the CE is. The UE1 is the MTC UE of the CEL0, and the UE2 is the MTC UE of the CEL1; the first message is the Msg3 message, and the second message is the RAR message; as shown in FIG. 6, the communication method of the present embodiment includes the following steps.

In step 601, the MTC terminal acquires the first configuration information;

here, the first configuration information is used for the MTC terminal to determine the time of sending the Msg3 message.

This step includes that: the MTC terminal acquires the first configuration information through the scheduling information of the RAR message sent by the eNB.

Before this step, the method further includes that: the eNB allocates the PRACH resources for the MTC terminal, herein the PRACH resources include: the random access preamble used by the random access signaling, the subframe used for sending the random access preamble and the PRB.

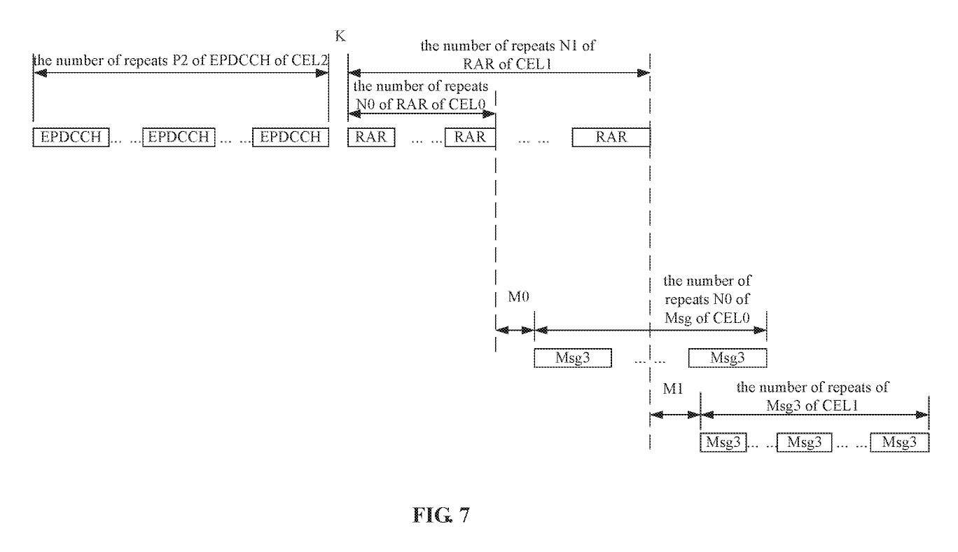

After this step, the method further includes that: the MTC terminal receives the RAR message sent by the eNB; the RAR message includes the RAR information; the mode of sending the RAR message is a repeated sending mode; the numbers of times of sending the RAR messages corresponding to the MTC terminals with different levels are different; as shown in FIG. 7, the number of times of sending the RAR messages corresponding to the UE1 is N0, and the number of times of sending the RAR messages corresponding to the UE2 is N1.

In an embodiment, the scheduling information of the RAR message is included in the DCI and sent through the EPDCCH.

In the present embodiment, the mode of sending the scheduling information of the RAR message is a repeated sending mode, and the number of repeats is the number of times of sending the scheduling information of the RAR message corresponding to the MTC terminal with the highest level; in the present embodiment, the MTC terminal with the highest level configured for the eNB is the MTC terminal with the level of CEL2; as shown in FIG. 7, the number of times of sending the scheduling information of the RAR message is the number of times P2 of sending the scheduling information of the RAR message corresponding to the MTC terminal with the level of CEL2.

In an embodiment, the first configuration information comprises: the first time interval M:

correspondingly, the step that the MTC terminal determines the time of sending the Msg3 message comprises:

the MTC terminal determines a time after a first time as a second time, herein the time interval length between the first time and the second time is M, and determines a time corresponding to the first uplink RB after the second time as the time of sending the Msg3 message;

here, the first time is a time when sending of an RAR message corresponding to the level of the MTC terminal is ended for the last time, when the RAR message is sent repeatedly;

the unit of measuring the first time interval M can be subframe or frame or other units of measuring time; for the second nodes with different levels, the lengths of the first time intervals M can be either the same or different; in the present embodiment, the first time interval M corresponding to the UE1 is M0, and the first time interval M corresponding to the UE2 is M1, that is, the scheduling information of the RAR message includes the first configuration information corresponding to two MTC terminals, as shown in FIG. 7.

In an embodiment, before the MTC terminal receives the RAR message sent by the eNB, the method further includes that: the MTC terminal determines the time when sending of the RAR message is started;

the step that the MTC terminal determines the time when sending of the RAR message is started includes:

the MTC terminal determines a time after a third time as a fourth time, herein the time interval length between the third time and the fourth time is N. and determines a time corresponding to the first available downlink RB after the fourth time as the time when sending of the RAR message is started; or, the MTC terminal determines a time corresponding to the first downlink RB after the fourth time as the time when sending of the RAR message is started;

herein, the lengths of the second time intervals N corresponding to the MTC terminals with different levels can be either the same or different; when the lengths of the second time intervals N corresponding to the MTC terminals with different levels are different, the value of the second time interval N corresponding to the MTC terminal with the high level is greater than the value of the second time interval N corresponding to the MTC terminal with the low level; the unit of measuring the second time interval N can be subframe or frame or other units of measuring time; in the embodiment of the disclosure, the lengths of the second time intervals N corresponding to the UE1 and the UE2 are the same; and the length of the second time interval N is K subframes, as shown in FIG. 7;

the third time is a time when sending of the scheduling information of the RAR message is ended for the last time, as shown in FIG. 7.

In an embodiment, before the time when sending of the RAR message is started is determined, the method further comprises that: the second time interval N is acquired;

the step that the second time interval N is acquired includes: the second time interval N is acquired through the SI; or, the second time interval N is acquired through the scheduling information of the RAR message.

In an embodiment, the scheduling information of the RAR message comprises at least one of the first adjustment information and the first indication information;

herein, the first adjustment information comprises one or more of the adjustment information of the modulation order of the RAR message, the adjustment information of the coding rate of the RAR message, the adjustment information of the modulation coding rate of the RAR message, the updated modulation order information of the RAR message, the updated coding rate information of the RAR message, and the updated modulation coding rate information of the RAR message;

the first adjustment information can be expressed by the relative amount and/or the absolute amount;

when the first adjustment information is expressed by the relative amount, the adjustment information includes: one or more of the adjustment information of the modulation order of the RAR message, the adjustment information of the coding rate of the RAR message and the adjustment information of the modulation coding rate of the RAR message:

herein, the adjustment information of the modulation order of the RAR message is relative to the modulation order information of the RAR message;

the adjustment information of the coding rate of the RAR message is relative to the coding rate information of the RAR message;

the adjustment information of the modulation coding rate of the RAR message is relative to the modulation coding rate information of the RAR message.

When the first adjustment information is expressed by the absolute amount, the adjustment information comprises one or more of the updated modulation order information of the RAR message, the updated coding rate information of the RAR message, and the updated modulation coding rate information of the RAR message.

The first indication information comprises the index of frequency band resources where the RAR message is, for indicating the frequency band resources where the RAR message is.

In step 602, the Msg3 message is sent to the eNB according to the first configuration information;

this step includes that: the MTC terminal determines the time of sending the Msg3 message according to the first configuration information, and sends the Msg3 message to the eNB at the time of sending the Msg3 message:

herein, the Msg3 message includes the unique identifier of the MTC terminal, for differentiating the different MTC terminals; the Msg3 message further includes the RRC connection request message, or the RRC connection reestablishment request message, or the RRC connection reconfiguration completion message.

In an embodiment, the mode of sending the Msg3 message is a repeated sending mode; the numbers of times of sending the Msg3 messages corresponding to the MTC terminals with different levels are different; as shown in FIG. 7, the number of times of sending the Msg3 message corresponding to the UE1 is N0, and the number of times of sending the Msg3 message corresponding to the UE2 is N1.

### Fifth Embodiment

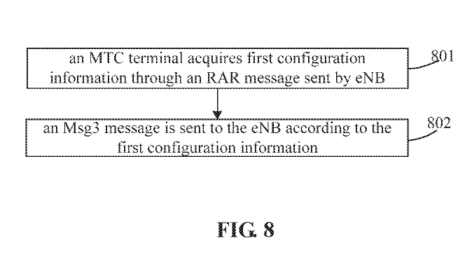

FIG. 8 is a flowchart of a communication method according to a fifth embodiment of the disclosure. The method of the present embodiment is applied to the random access scenario in the LTE system. In the present embodiment, the first node is the eNB; the second node is the MTC terminal UE; the MTC terminal supports the CE, and the PRACH supports two CELs, respectively CEL0 and CEL1. UE1 is the MTC UE of the CEL0, and UE2 is the MTC UE of the CEL1; the first message is the Msg3 message, and the second message is the RAR message; as shown in FIG. 8, the communication method of the present embodiment includes the following steps.

In step 801, the MTC terminal acquires the first configuration information through the RAR message sent by the eNB;

here, the first configuration information is used for the MTC terminal to determine the time of sending the Msg3 message.

Before this step, the method further includes that: the eNB allocates the PRACH resources for the MTC terminal, herein the PRACH resources include: the random access preamble used by the random access signaling, the subframe used for sending the random access preamble and the PRB.

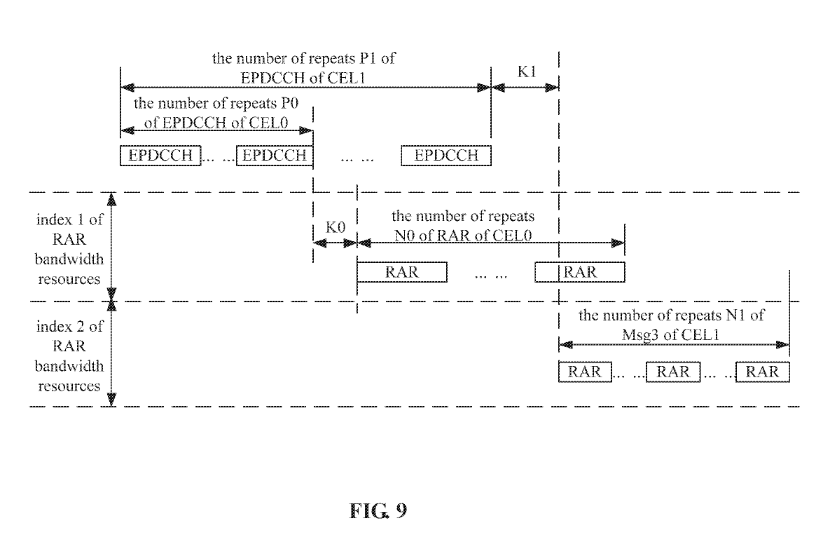

In an embodiment, the mode of sending the RAR message is a repeated sending mode; the numbers of times of sending the RAR messages corresponding to the MTC terminals with different levels are different; as shown in FIG. 9, the number of times of sending the RAR message corresponding to the UE1 is N0, and the number of times of sending the RAR message corresponding to the UE2 is N1.

In an embodiment, before this step, the method further includes that: the scheduling information of the RAR message sent by the eNB is received;

here, the scheduling information of the RAR message is included in the DCI and sent through the EPDCCH.

In the present embodiment, the mode of sending the scheduling information of the RAR message is a repeated sending mode; the MTC terminals with different levels correspond to different numbers of repeats; as shown in FIG. 9, the number of times of sending the scheduling information of the RAR message corresponding to the UE1 is P0, and the number of times of sending the scheduling information of the RAR message corresponding to the UE2 is P1.

In an embodiment, the first configuration information includes: the first time interval M:

correspondingly, the step that the MTC terminal determines the time of sending the Msg3 message comprises:

the MTC terminal determines a time after a first time as a second time, herein the time interval length between the first time and the second time is M. and determines a time corresponding to the first available uplink RB after the second time as the time of sending the Msg3 message; here, the first time is a time when sending of the RAR message corresponding to the level of the MTC terminal is ended for the last time, when the RAR message is sent repeatedly:

the unit of measuring the first time interval M can be subframe or frame or other units of measuring time, for the second nodes with different levels, the lengths of the first time intervals M can be either the same or different.

In an embodiment, before the MTC terminal receives the RAR message sent by the eNB, the method further includes that: the MTC terminal determines the time when sending of the RAR message is started:

the step that the MTC terminal determines the time when sending of the RAR message is started includes:

the MTC terminal determines a time after a third time as a fourth time, herein the time interval length between the third time and the fourth time is N, and determines a time corresponding to the first available downlink RB after the fourth time as the time when sending of the RAR message is started:

in the present embodiment, the lengths of the second time intervals N corresponding to the MTC terminals with different levels are different; as shown in FIG. 9, the length of the second time interval N corresponding to the UE1 is K0, and the length of the second time interval N corresponding to the UE2 is K1;

the third time is a time when sending of the scheduling information of the RAR message is ended for the last time, as shown in FIG. 9.

In an embodiment, before the time when sending of the RAR message is started is determined, the method further comprises that: the second time interval N is acquired:

in the present embodiment, the step that the second time interval N is acquired includes: the second time interval N is acquired through the SI.

In an embodiment, the scheduling information of the RAR message comprises at least one of the first adjustment information and the first indication information;

herein, the first adjustment information comprises one or more of the adjustment information of the modulation order of the RAR message, the adjustment information of the coding rate of the RAR message, the adjustment information of the modulation coding rate of the RAR message, the updated modulation order information of the RAR message, the updated coding rate information of the RAR message, and the updated modulation coding rate information of the RAR message;

the first adjustment information can be expressed by the relative amount and/or the absolute amount;

when the first adjustment information is expressed by the relative amount, the adjustment information includes: one or more of the adjustment information of the modulation order of the RAR message, the adjustment information of the coding rate of the RAR message and the adjustment information of the modulation coding rate of the RAR message:

herein, the adjustment information of the modulation order of the RAR message is relative to the modulation order information of the RAR message;

the adjustment information of the coding rate of the RAR message is relative to the coding rate information of the RAR message;

the adjustment information of the modulation coding rate of the RAR message is relative to the modulation coding rate information of the RAR message.

When the first adjustment information is expressed by the absolute amount, the adjustment information comprises one or more of the updated modulation order information of the RAR message, the updated coding rate information of the RAR message, and the updated modulation coding rate information of the RAR message.

In the present embodiment, the first adjustment information is the adjustment information of the coding rate of the RAR message; the adjustment information of the coding rate of the RAR message corresponding to the UE1 is 5, and the adjustment information of the coding rate of the RAR message corresponding to the UE2 is 3; there is a one-to-one corresponding relationship between the adjustment information of the coding rate and the coding rate, as shown in Table 1 below; the UE1 can learn, by looking up Table 1, that there is no need to adjust the coding rate, and the UE2 learns, by looking up Table 1, that it is needed to reduce 0.2 based on the learned coding rate. Herein, the learned coding rate is indicated in the SI or in the scheduling information of the RAR message sent to the MTC terminal; in the present embodiment, the MTC terminal learns the new coding rate of the RAR message according to the learned coding rate of the RAR message and the adjustment information of the coding rate of the RAR message, and then successfully decodes, in the repeatedly sent RAR, the RAR message sent to itself;

TABLE 1

| Adjustment information | |
|---|---|
| of coding rate | Variation of coding rate |
| 0 | Reduced by 0.5 |
| 1 | Reduced by 0.4 |
| 2 | Reduced by 0.3 |
| 3 | Reduced by 0.2 |
| 4 | Reduced by 0.1 |
| 5 | 0 |
| 6 | Increased by 0.1 |
| 6 | Increased by 0.2 |
| 6 | Increased by 0.3 |
| 6 | Increased by 0.4 |
| 6 | Increased by 0.5 |

The first indication information comprises the index of frequency band resources where the RAR message is, for indicating the frequency band resources where the RAR message is; in the present embodiment, the index of frequency band resources which the RAR message of the UE1 is in is 1, and the index of frequency band resources which the RAR message of the UE2 is in is 2, as shown in FIG. 9.

In step 802, the Msg3 message is sent to the eNB according to the first configuration information;

this step includes that: the MTC terminal determines the time of sending the Msg3 message according to the first configuration information, and sends the Msg3 message to the eNB at the time of sending the Msg3 message;

herein, the Msg3 message includes the unique identifier of the MTC terminal, for differentiating the different MTC terminals; the Msg3 message further includes the RRC connection request message, or the RRC connection reestablishment request message, or the RRC connection reconfiguration completion message.

In an embodiment, the mode of sending the Msg3 message is a repeated sending mode; the numbers of times of sending the Msg3 messages corresponding to the MTC terminals with different levels are different.

### Embodiment 6

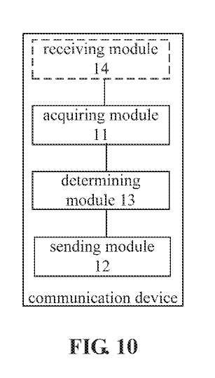

FIG. 10 is a structure diagram of a communication device according to an embodiment of the disclosure; the device is in the second node. As shown in FIG. 10, the structure of the communication device of the present embodiment includes: an acquiring module 11, a sending module 12 and a determining module 13; herein,

the acquiring module 11 is configured to acquire the first configuration information sent by the first node; and

the sending module 12 is configured to send the first message to the first node according to the first configuration information;

herein, the first configuration information is used for the determining module 13 to determine the time of sending the first message.

In an embodiment, the device further includes a receiving module 14 configured to receive the second message sent by the first node.

In an embodiment, the acquiring module 11 acquires the first configuration information sent by the first node includes:

the acquiring module 11 acquires the first configuration information through the second message sent by the first node; or

the acquiring module 11 acquires the first configuration information through the SI sent by the first node; or

the acquiring module 11 acquires the first configuration information through the scheduling information of the second message sent by the first node;

herein, the scheduling information of the second message can be included in the DCI and sent through the EPDCCH;

the mode of sending the scheduling information of the second message by the first node is sending once, namely a non-repeated sending mode, or a repeated sending mode;

when the mode of sending the scheduling information of the second message by the first node is a repeated sending mode, the number of repeats is the number of times of sending scheduling information of a second message corresponding to the second node with the highest level among the second messages,

or the number of times of sending scheduling information of a second message corresponding to a second node with the highest level which is configured for the first node;

here, the level can be the CEL, or the PRACH CEL, or the PRACH repeated sending level;

the numbers of times of sending the scheduling information of the second messages corresponding to the second nodes with different levels are different.

In an embodiment, the first configuration information comprises: the first time interval M:

correspondingly, the determining module 13 is configured to determine a time after a first time as a second time, herein the time interval length between the first time and the second time is M, and determine a time corresponding to the first available uplink RB after the second time as the time of sending the first message; or, the determining module is configured to determine a time corresponding to the first uplink RB after the second time is the time of sending the first message;

here, the unit of measuring the first time interval M can be subframe or frame or other units of measuring time;

for the second nodes with different levels, the lengths of the first time intervals M can be either the same or different.

In an embodiment, the mode of sending the second message by the first node can be either a non-repeated sending mode, namely sending once, or a repeated sending mode; when the mode of sending the second message is a repeated sending mode, the numbers of times of sending the second messages corresponding to the second nodes with different levels are different;

correspondingly,

when the mode of sending the second message is a non-repeated sending mode, the first time is the time of sending the second message; or

when the mode of sending the second message is a non-repeated sending mode, the first time is the time when sending of the second message is started; or

when the mode of sending the second message is a non-repeated sending mode, the first time is the time when sending of the second message is ended; or

when the mode of sending the second message is a repeated sending mode, the first time is a time when sending of a second message corresponding to the level of the second node is ended for the last time; or

when the mode of sending the second message is a repeated sending mode, the first time is the time when sending of the second message is ended for the last time; or

the first time is a start time of a detection time window of the second message corresponding to the level of the second node; or

the first time is an end time of the detection time window of the second message corresponding to the level of the second node; or

the first time is a start time of the detection time window of the second message; or

the first time is an end time of the detection time window of the second message;

here, the lengths of the detection time windows of the second messages corresponding to the second nodes with different levels are different.

In an embodiment, the mode of sending the scheduling information of the second message by the first node is sending once or sending repeatedly;

when the mode of sending the scheduling information of the second message by the first node is sending repeatedly, the number of repeats is the number of times of sending scheduling information of a second message corresponding to the second node with the highest level among the second messages, or

the number of times of sending scheduling information of a second message corresponding to a second node with the highest level which is configured for the first node.

In an embodiment, the determining module 13 is further configured to determine the time when sending of the second message is started;

the determining module 13 is configured to determine a time after a third time as a fourth time, herein the time interval length between the third time and the fourth time is N. and determine a time corresponding to the first available downlink RB after the fourth time as the time when sending of the second message is started; or, the determining module is configured to determine a time corresponding to the first downlink RB after the fourth time as the time when sending of the second message is started;

herein, the lengths of the second time intervals N corresponding to the second nodes with different levels can be either the same or different; when the lengths of the second time intervals N corresponding to the second nodes with different levels are different, the value of the second time interval N corresponding to the second node with the high level is greater than the value of the second time interval N corresponding to the second node with the low level; the unit of measuring the second time interval N can be subframe or frame or other units of measuring time;

in an embodiment, when the mode of sending the scheduling information of the second message is a non-repeated sending mode, the third time is the time of sending the scheduling information of the second message; or

when the mode of sending the scheduling information of the second message is a non-repeated sending mode, the third time is the time when sending of the scheduling information of the second message is started; or

when the mode of sending the scheduling information of the second message is a non-repeated sending mode, the third time is the time when sending of the scheduling information of the second message is ended; or

when the mode of sending the scheduling information of the second message is a repeated sending mode, the third time is the time when sending of the scheduling information of the second message is ended for the last time; or

the third time is a start time of the detection time window of the scheduling information of the second message; or

the third time is an end time of the detection time window of the scheduling information of the second message.

In an embodiment, the acquiring module 11 is further configured to acquire the second time interval N;

the acquiring module 11 is configured to acquire the second time interval N through the SI,

or acquire the second time interval N through the scheduling information of the second message.

In an embodiment, the scheduling information of the second message comprises at least one of the first adjustment information and the first indication information;

herein, the first adjustment information comprises one or more of the adjustment information of the modulation order of the second message, the adjustment information of the coding rate of the second message, the adjustment information of the modulation coding rate of the second message, the updated modulation order information of the second message, the updated coding rate information of the second message, and the updated modulation coding rate information of the second message;

the first adjustment information can be expressed by the relative amount and/or the absolute amount:

when the first adjustment information is expressed by the relative amount, the adjustment information includes: one or more of the adjustment information of the modulation order of the second message, the adjustment information of the coding rate of the second message and the adjustment information of the modulation coding rate of the second message;

herein, the adjustment information of the modulation order of the second message is relative to the modulation order information of the second message; the adjustment information of the coding rate of the second message is relative to the coding rate information of the second message;

the adjustment information of the modulation coding rate of the second message is relative to the modulation coding rate information of the second message.

When the first adjustment information is expressed by the absolute amount, the adjustment information comprises one or more of the updated modulation order information of the second message, the updated coding rate information of the second message, and the updated modulation coding rate information of the second message.

The first indication information comprises the index of frequency band resources where the second message is, for indicating the frequency band resources where the second message is.

In an embodiment, the first message includes the unique identifier of the first node, for differentiating the different first nodes; the first message further includes the RRC connection request message, or the RRC connection reestablishment request message, or the RRC connection reconfiguration completion message.

In an embodiment, the mode of sending the first message can be either sending once or sending repeatedly; the numbers of times of sending the first messages corresponding to the second nodes with different levels are different.

In an embodiment, the first message is the Msg3 message, and the second message is the RAR message:

the first node can be the macrocell, or the microcell, or the picocell, or the femtocell, or the LPN, or the relay;

there can be one or more than one second node; the second node can be the H2H communication terminal, or the M2M communication terminal, or the D2D communication terminal, or the MTC terminal.

In the present embodiment, all of the acquiring module 11, the sending module 12, the determining module 13 and the receiving module 14 can be realized by a Central Processing Unit (CPU), or a Digital Signal Processor (DSP), or a Field Programmable Gate Array (FPGA), or an Application Specific Integrated Circuit (ASIC) in a server.

All of the acquiring module, the sending module, the determining module and the receiving module presented in the present embodiment can be realized by processors, and certainly specific logical circuits; in practical applications, the processor can be the CPU, or the Micro Processor Unit (MPU) or the FPGA.

Those skilled in the art should appreciate that the embodiments of the disclosure can be provided as a method, a system or a computer program product. So, the disclosure can adopt the forms of full hardware embodiment, full software embodiment, or embodiment combining software and hardware. Besides, the disclosure can adopt the form of a computer program product which is implemented on one or more computer available storage media including computer available program codes, herein the storage media include, but are not limited to, a magnetic disk memory and an optical memory.

If the communication method is implemented in form of software function modules, and the software function modules are sold or used as independent products, they can also be stored in a computer readable storage medium. Based on this understanding, the technical solutions in the embodiments of the disclosure substantially or the part making a contribution to the traditional art can be embodied in the form of software product; the computer software product is stored in a storage medium and includes a number of instructions to make a computer device (which can be a personal computer, a server or a network device, etc.) perform all or part of the method in each embodiment of the disclosure. The above storage medium includes: a USB flash disk, a mobile hard disk, an ROM, a magnetic disk or a compact disc, and other media which can store program codes. In this way, the disclosure is not limited to any particular combination of hardware and software.

Correspondingly, the embodiment of the disclosure also provides a computer storage medium, in which a computer program is stored, herein the computer program is used for performing the communication method above.

The above is only the preferred embodiments of the disclosure and not intended to limit the scope of protection of the disclosure.

1. A communication method, comprising:
acquiring, by a second node, first configuration information sent by a first node; and
sending a first message to the first node according to the first configuration information;
wherein the first configuration information is used for determining a time of sending the first message,
wherein the method further comprises: before acquiring the first configuration information sent by the first node, receiving a second message sent by the first node,
wherein acquiring, by the second node, the first configuration information sent by the first node comprises:
acquiring, by the second node, the first configuration information through the second message sent by the first node; or
acquiring, by the second node, the first configuration information through System Information (SI) sent by the first node; or
acquiring, by the second node, the first configuration information through scheduling information of the second message sent by the first node,
wherein the first configuration information comprises: a first time interval M;
correspondingly, determining the time of sending the first message comprises:
determining a time after a first time as a second time, therein the time interval length between the first time and the second time is M, and determining a time corresponding to a first uplink Resource Block (RB) after the second time as the time of sending the first message,
wherein when a mode of sending the second message is a non-repeated sending mode, the first time is the time of sending the second message; or
when the mode of sending the second message is a non-repeated sending mode, the first time is a time when sending of the second message is started; or
when the mode of sending the second message is a non-repeated sending mode, the first time is a time when sending of the second message is ended; or
when the mode of sending the second message is a repeated sending mode, the first time is a time when sending of a second message corresponding to the level of the second node is ended for the last time; or
when the mode of sending the second message is a repeated sending mode, the first time is a time when sending of the second message is ended for the last time; or
the first time is a start time of a detection time window of the second message corresponding to the level of the second node; or
the first time is an end time of the detection time window of the second message corresponding to the level of the second node; or
the first time is a start time of the detection time window of the second message; or
the first time is an end time of the detection time window of the second message.

2-5. (canceled)

6. The method according to claim 1, wherein the scheduling information of the second message is included in Downlink Control Information (DCI).

7. The method according to claim 1, wherein the mode of sending the scheduling information of the second message by the first node is sending once or sending repeatedly;
when the mode of sending the scheduling information of the second message by the first node is sending repeatedly, the number of repeats is the number of times of sending scheduling information of a second message corresponding to the second node with the highest level among the second messages, or the number of times of sending scheduling information of a second message corresponding to a second node with the highest level which is configured for the first node.

8. The method according to claim 7, wherein before receiving the second message sent by the first node, the method further comprises: determining a time when sending of the second message is started;
determining the time when sending of the second message is started comprises:
determining a time after a third time as a fourth time, wherein the time interval length between the third time and the fourth time is N, and determining a time corresponding to a first available downlink RB after the fourth time as the time when sending of the second message is started; or, determining a time corresponding to a first downlink RB after the fourth time as the time when sending of the second message is started.

9. The method according to claim 8, wherein
when the mode of sending the scheduling information of the second message is anon-repeated sending mode, the third time is the time of sending the scheduling information of the second message; or
when the mode of sending the scheduling information of the second message is anon-repeated sending mode, the third time is a time when sending of the scheduling information of the second message is started; or
when the mode of sending the scheduling information of the second message is anon-repeated sending mode, the third time is a time when sending of the scheduling information of the second message is ended; or
when the mode of sending the scheduling information of the second message is a repeated sending mode, the third time is a time when sending of the scheduling information of the second message is ended for the last time; or
the third time is a start time of a detection time window of the scheduling information of the second message; or,
the third time is an end time of the detection time window of the scheduling information of the second message.

10. The method according to claim 8, wherein before determining the time when sending of the second message is started, the method further comprises: acquiring a second time interval N;
acquiring the second time interval N comprises: acquiring the second time interval N through the SI; or
acquiring the second time interval N through the scheduling information of the second message.

11. The method according to claim 1, wherein the scheduling information of the second message comprises at least one of first adjustment information and first indication information.

12. The method according to claim 1, wherein the scheduling information of the second message comprises first adjustment information;
correspondingly, the first adjustment information comprises one or more of: adjustment information of a modulation order of the second message, adjustment information of a coding rate of the second message, adjustment information of a modulation coding rate of the second message, updated modulation order information of the second message, updated coding rate information of the second message, and updated modulation coding rate information of the second message.

13. The method according to claim 1, wherein the scheduling information of the second message comprises the first indication information;
correspondingly, the first indication information comprises an index of frequency band resources where the second message is, for indicating the frequency band resources where the second message is.

14. The method according to claim 1, wherein the first message comprises: a Radio Resource Control (RRC) connection request message, or an RRC connection reestablishment request message, or an RRC connection reconfiguration completion message.

15. The method according to claim 1, wherein the first message is an Msg3 message, and the second message is a Random Access Response (RAR) message.

16. A communication device, which is in a second node, comprising:
a memory storing processor-executable instructions, and
a processor arranged to execute the stored processor-executable instructions to perform steps of:
acquiring first configuration information sent by a first node; and
sending a first message to the first node according to the first configuration information;
wherein the first configuration information is used for determining a time of sending the first message,
wherein the method further comprises: before acquiring the first configuration information sent by the first node, receiving a second message sent by the first node,
wherein acquiring, by the second node, the first configuration information sent by the first node comprises:
acquiring, by the second node, the first configuration information through the second message sent by the first node; or
acquiring, by the second node, the first configuration information through System Information (SI) sent by the first node; or
acquiring, by the second node, the first configuration information through scheduling information of the second message sent by the first node,
wherein the first configuration information comprises: a first time interval M;
correspondingly, determining the time of sending the first message comprises:
determining a time after a first time as a second time, wherein the time interval length between the first time and the second time is M, and determining a time corresponding to a first uplink Resource Block (RB) after the second time as the time of sending the first message,
wherein when a mode of sending the second message is a non-repeated sending mode, the first time is the time of sending the second message; or
when the mode of sending the second message is a non-repeated sending mode, the first time is a time when sending of the second message is started; or
when the mode of sending the second message is a non-repeated sending mode, the first time is a time when sending of the second message is ended; or
when the mode of sending the second message is a repeated sending mode, the first time is a time when sending of a second message corresponding to the level of the second node is ended for the last time; or
when the mode of sending the second message is a repeated sending mode, the first time is a time when sending of the second message is ended for the last time; or
the first time is a start time of a detection time window of the second message corresponding to the level of the second node; or
the first time is an end time of the detection time window of the second message corresponding to the level of the second node; or
the first time is a start time of the detection time window of the second message; or
the first time is an end time of the detection time window of the second message.

17-20. (canceled)

21. The device according to claim 16, wherein the mode of sending the scheduling information of the second message by the first node is sending once or sending repeatedly;
when the mode of sending the scheduling information of the second message by the first node is sending repeatedly, the number of repeats is the number of times of sending scheduling information of a second message corresponding to the second node with the highest level among the second messages, or the number of times of sending scheduling information of a second message corresponding to a second node with the highest level which is configured for the first node.

22. The device according to claim 21, wherein before receiving the second message sent by the first node, the method further comprises: determining a time when sending of the second message is started:
determining the time when sending of the second message is started comprises:
determining a time after a third time as a fourth time, wherein the time interval length between the third time and the fourth time is N, and determine a time corresponding to a first available downlink RB after the fourth time as the time when sending of the second message is started; or, the determining module is configured to determine a time corresponding to a first downlink RB after the fourth time as the time when sending of the second message is started.

23. The device according to claim 22, wherein,
when the mode of sending the scheduling information of the second message is anon-repeated sending mode, the third time is the time of sending the scheduling information of the second message; or
when the mode of sending the scheduling information of the second message is a non-repeated sending mode, the third time is the time when sending of the scheduling information of the second message is started; or
when the mode of sending the scheduling information of the second message is anon-repeated sending mode, the third time is the time when sending of the scheduling information of the second message is ended; or
when the mode of sending the scheduling information of the second message is a non-repeated sending mode, the third time is the time when sending of the scheduling information of the second message is ended for the last time; or
the third time is a start time of the detection time window of the scheduling information of the second message; or
the third time is an end time of the detection time window of the scheduling information of the second message.

24. The device according to claim 22, wherein before determining the time when sending of the second message is started, the method further comprises: acquiring a second time interval N;
acquiring the second time interval N comprises: acquiring the second time interval N through the SI; or
acquiring the second time interval N through the scheduling information of the second message.

25. A non-transitory computer storage medium having stored therein computer executable instructions used for performing a communication method, the method comprising:
acquiring, by a second node, first configuration information sent by a first node; and
sending a first message to the first node according to the first configuration information;
wherein the first configuration information is used for determining a time of sending the first message,
wherein the method further comprises: before acquiring the first configuration information sent by the first node, receiving a second message sent by the first node,
wherein acquiring, by the second node, the first configuration information sent by the first node comprises:
acquiring, by the second node, the first configuration information through the second message sent by the first node; or
acquiring, by the second node, the first configuration information through System Information (SI) sent by the first node; or
acquiring, by the second node, the first configuration information through scheduling information of the second message sent by the first node,
wherein the first configuration information comprises: a first time interval M;
correspondingly, determining the time of sending the first message comprises:
determining a time after a first time as a second time, wherein the time interval length between the first time and the second time is M, and determining a time corresponding to a first uplink Resource Block (RB) after the second time as the time of sending the first message,
wherein when a mode of sending the second message is a non-repeated sending mode, the first time is the time of sending the second message; or
when the mode of sending the second message is a non-repeated sending mode, the first time is a time when sending of the second message is started; or
when the mode of sending the second message is a non-repeated sending mode, the first time is a time when sending of the second message is ended; or
when the mode of sending the second message is a repeated sending mode, the first time is a time when sending of a second message corresponding to the level of the second node is ended for the last time; or
when the mode of sending the second message is a repeated sending mode, the first time is a time when sending of the second message is ended for the last time; or
the first time is a start time of a detection time window of the second message corresponding to the level of the second node; or
the first time is an end time of the detection time window of the second message corresponding to the level of the second node; or
the first time is a start time of the detection time window of the second message; or
the first time is an end time of the detection time window of the second message.

26. The method according to claim 1, wherein determining the time corresponding to the first uplink RB after the second time as the time of sending the first message comprises:
determining a time corresponding to a first available uplink RB after the second time as the time of sending the first message.

27. The device according to claim 16, wherein determining the time corresponding to the first uplink RB after the second time as the time of sending the first message comprises:
determining a time corresponding to a first available uplink RB after the second time as the time of sending the first message.

28. The non-transitory computer storage medium according to claim 25, wherein determining the time corresponding to the first uplink RB after the second time as the time of sending the first message comprises:
determining a time corresponding to a first available uplink RB after the second time as the time of sending the first message.
